(19) United States
(12) Patent Application Publication
(10) Pub. No.: US 2011/0036092 A1
(43) Pub. Date: Feb. 17, 2011

(54) Methods and Systems for Dry Low NOx Combustion Systems

(75) Inventors: William James Lawson, Niskayuna, NY (US); Daniel Robert Coffey, Schenectady, NY (US); Erhan Karaca, Clifton Park, NY (US)

Correspondence Address: CANTOR COLBURN LLP, 20 Church Street, 22nd Floor, Hartford, CT, 06103, US

(73) Assignee: General Electric Company, Schenectady, NY (US)

(21) Appl. No.: 12/539,923

(22) Filed: Aug. 12, 2009

(51) Int. Cl. F02C 9/40; F02C 7/22

(52) U.S. Cl. 60/772; 60/734

(57) ABSTRACT

A fuel system comprises a fuel nozzle having a first port and a second port, a first manifold connected to the first port, and a first inert gas buffer portion disposed between the first manifold and a source of compressed air.

### BACKGROUND OF THE INVENTION

The subject matter disclosed herein relates to gas turbine fuel systems and more particularly to fuel systems for Dry Low Nitrogen Oxide (NOx) combustion systems.

High hydrogen content low BTU gaseous fuel (synthetic gas) may be derived from a variety of sources including, for example, coal gasification processes or alternative sources such as coke gas and other industrial chemical processes.

Dry Low NOx (DLN) systems may include the use of synthetic gas or other types of gas having a relatively high hydrogen content that is blended with a high BTU gaseous fuel such as, for example, natural gas.

### BRIEF DESCRIPTION OF THE INVENTION

According to one aspect of the invention, a fuel system comprises a fuel nozzle having a first port and a second port, a first manifold connected to the first port, and a first inert gas buffer portion disposed between the first manifold and a source of compressed air.

According to another aspect of the invention, a method of controlling a fuel system comprises purging a first fuel source manifold with an inert gas, purging an inert gas buffer portion of the fuel system with the inert gas, closing a vent valve connected to the inert gas buffer portion, and stopping the purge of the first fuel source manifold.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is exemplary embodiment of a fuel system.

FIGS. 2-9 illustrate exemplary alignments of the fuel system of FIG. 1.

The detailed description explains embodiments of the invention, together with advantages and features, by way of example with reference to the drawings.

### DETAILED DESCRIPTION OF THE INVENTION

Dry Low NOx (DLN) gas turbine systems often use a fuel such as, for example, synthetic gas that has a H2 content less than 5% and a natural gas fuel. The use of a fuel having a higher H2 content (greater than 5%) hereinafter, H2 blend gas increases the risk of undesirable combustion in the piping and manifolds of the fuel system. The system and methods described below include a DLN system that allows H2 blend gas and natural gas to be safely used over a range of gas turbine system operating modes.

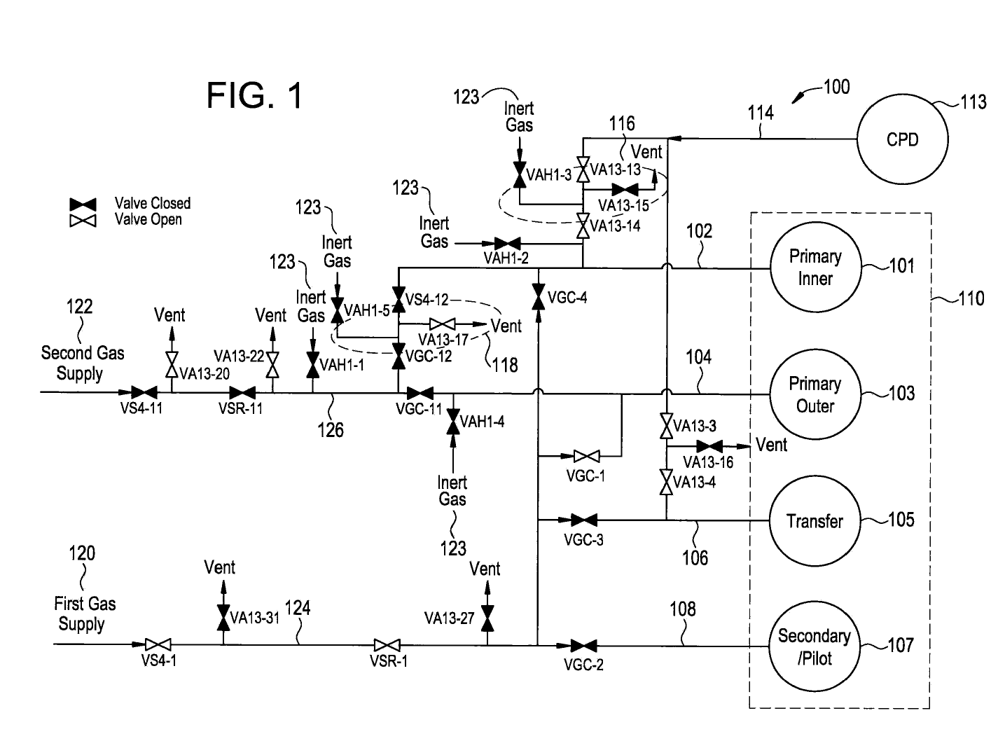

FIG. 1 illustrates an exemplary embodiment of a fuel system 100. FIG. 1 shows an example of the fuel system 100 in a turbine light off mode that will be described in detail below. The system 100 includes one or more fuel nozzles 110 that may have a plurality of ports. In the illustrated embodiment the ports include a primary inner port 101, a primary outer port 103, a transfer port 105, and a secondary/pilot port 107. The ports are each connected to an associated manifold that directs gas to the port. The manifolds include a primary inner manifold 102, a primary outer manifold 104, a transfer manifold 106, and a secondary manifold 108. Compressor discharge air (CPD) 113 is received from the compressor turbine (not shown) and is delivered to the system 100 via a CPD manifold 114. The CPD 113 is used to cool the fuel nozzle 110 and to purge manifolds. A first gas supply 120 that may include, for example, natural gas provides a first gas to the fuel nozzle 110 via a first gas supply manifold 124. The system 100 includes inert gas buffers 116 and 118. The inert gas buffers receive an inert gas 123 such as, for example N2 or CO2 from an inert gas supply (not shown). The inert gas buffers 116 and 118 may be used to separate the CPD 113 gas from gas received from a second gas supply 122. The second gas is provided to the fuel nozzle 110 via a second gas supply manifold 126. The system 100 includes a number of stop valves and flow control valves that control the flow of gas in the system.

FIG. 1 illustrates an example of the alignment of the system 100 in a light off mode. The shaded valves represent valves in a closed position, while the unshaded valves represent valves in an open position. In this regard, the VS4-1, VSR-1 and the VGC-1 valves are open allowing the primary outer port 103 to receive gas from the first gas supply 120 via the primary outer manifold 104. The VA13-13, VA13-14, VA13-3 and VA13-4 valves are open allowing the primary inner port 101 and the transfer port 105 to receive CPD air 113. The VGC-2 valve is closed, isolating the secondary port 107.

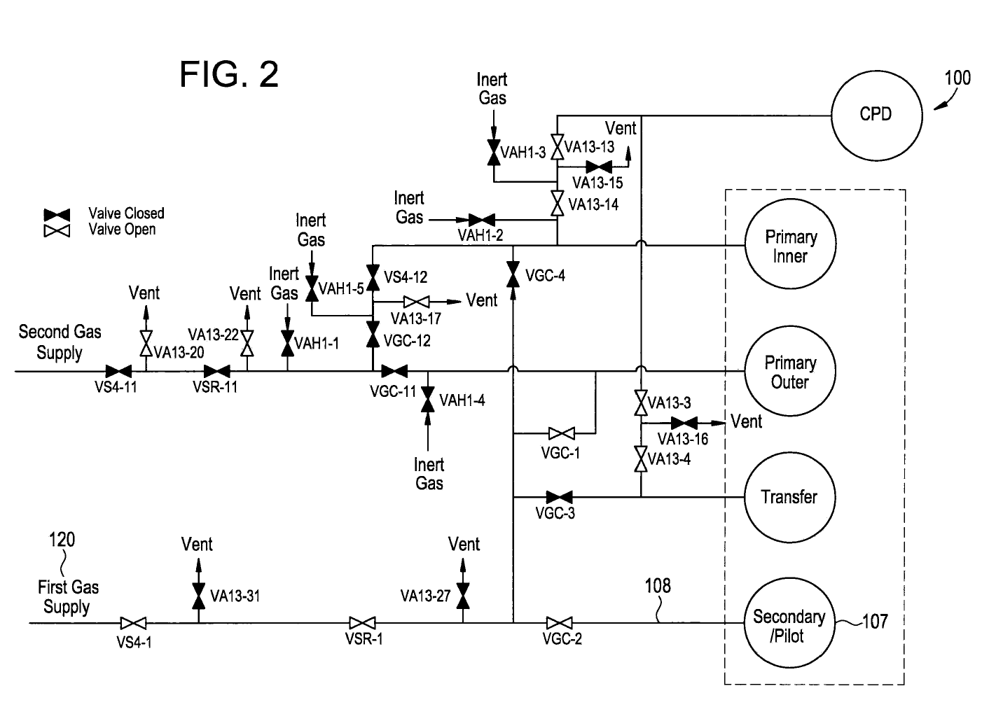

FIG. 2 illustrates an example of the alignment of the system 100 in a “lean-lean” fuel operating mode. The VGC-2 valve is open sending the gas from the first gas supply 120 to the secondary/pilot port 107 via the secondary manifold 108.

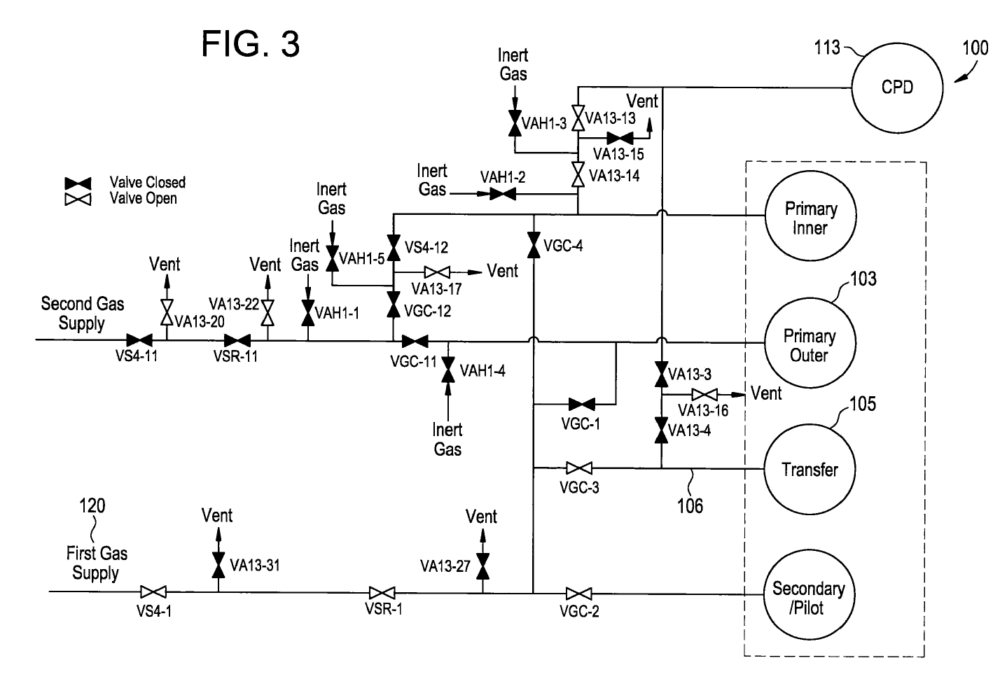

FIG. 3 illustrates an example of the alignment of the system 100 where the transfer port 105 receives fuel. In the illustrated example, the VA13-3 and VA13 4 valves have been closed stopping the flow of CPD 113 gas to the transfer manifold 106, while the VA13-16 valve has been opened to vent. The VGC-3 valve is opened allowing gas from the first gas supply 120 to flow to the transfer port 105 via the transfer manifold 106. The VGC-1 valve has been closed preventing fuel from flowing to the primary outer port 103.

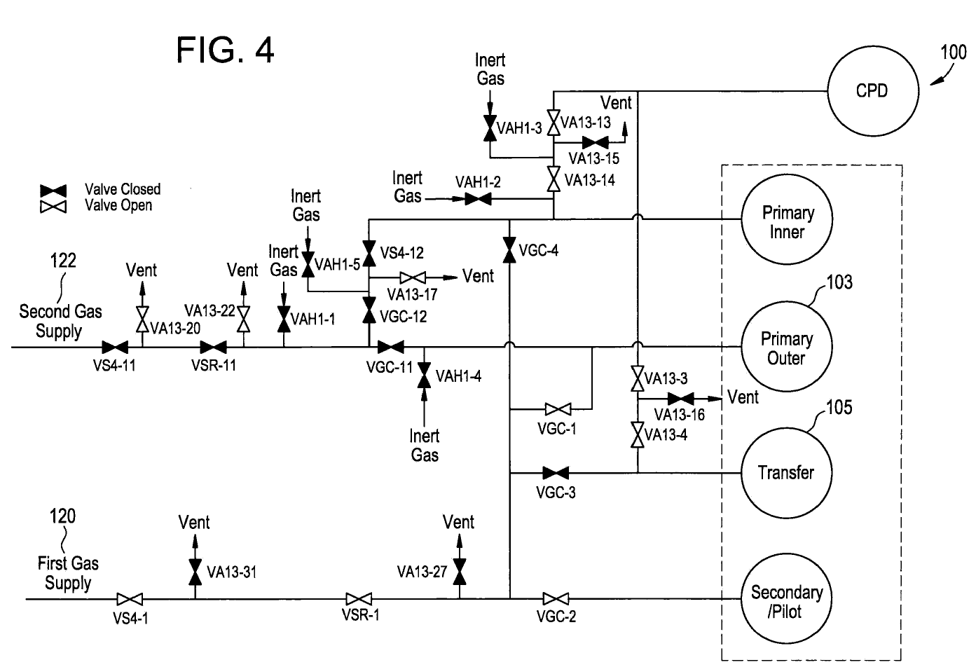

FIG. 4 illustrates an example of the alignment of the system 100 that prepares the system 100 to receive fuel from the first gas supply 120 and the second gas supply 122 and output the blended fuel via the primary outer port 103. The VGC 1 valve has been opened, allowing the fuel from the first gas supply 120 to flow to the primary outer port 103. The VGC-3 valve has been closed, preventing fuel from the first gas supply 120 from flowing to the transfer port 105. The valves VA13-3 and VA13-4 have been opened and the VA13-16 valve is closed allowing CPD 113 gas to flow to the transfer port 105.

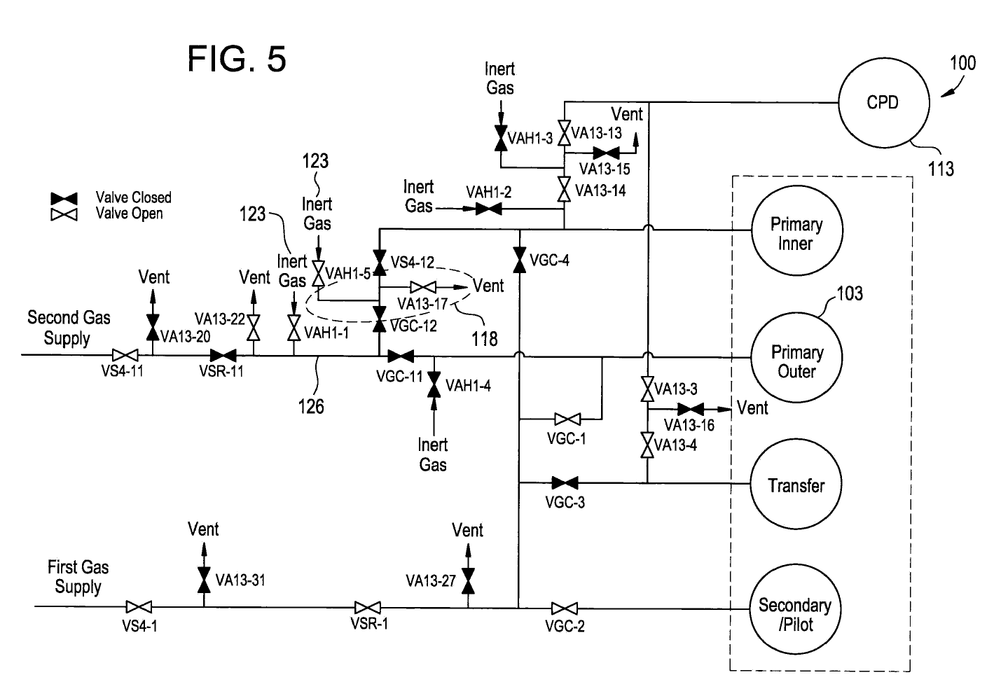

FIG. 5 illustrates an example of the alignment of the system 100 that further prepares the system to output blended fuel via the primary outer port 103. In the illustrated example, the VAH1-5 valve is opened. Opening the VAH1-5 valve allows inert gas 123 to flow through the inert gas buffer 118 and vent via the VA13 16 valve. The flow of inter gas 123 through the inert gas buffer 118 purges the inert gas buffer of any non-inert gas such as, for example, gaseous fuel or CPD air 113. The VAH1-1 valve is opened, purging the second gas supply manifold 126 with inert gas 123 that vents via the VA13-22 valve. The VA13-20 valve is closed, and the VS4-11 valve is opened.

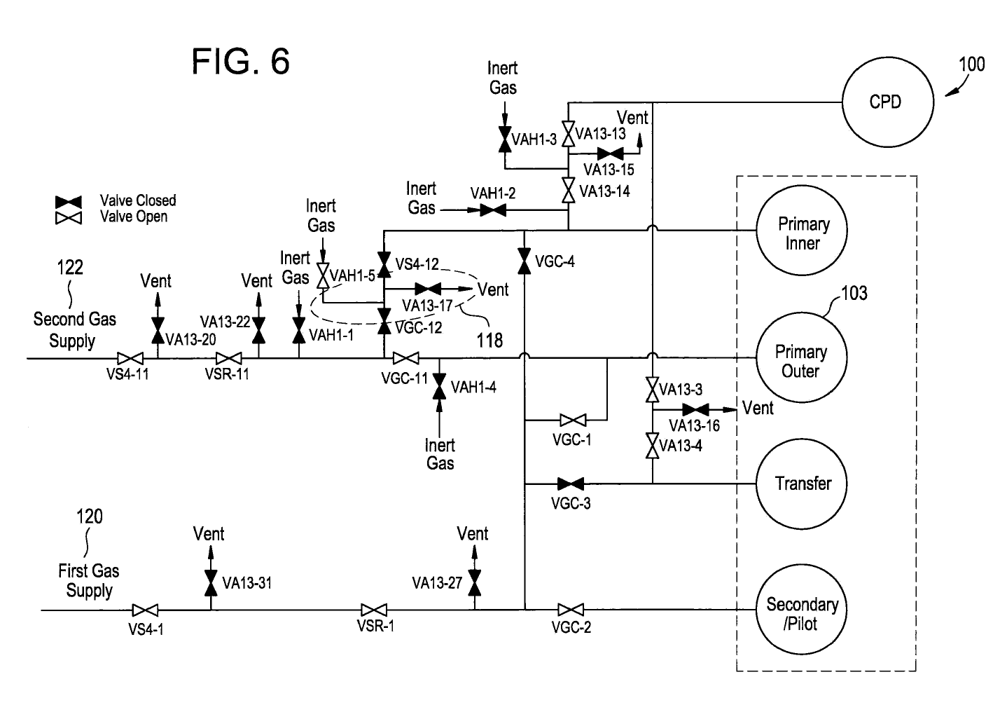

FIG. 6 illustrates an example of the alignment of the system 100 when the primary outer port 103 is receiving a blend of fuel from the first and second gas supplies 120 and 122. In the illustrated example, the VA13-17 valve is closed, and the inert gas 123 is maintained at a higher pressure than the CPD air 113, the first gas 120 and the second gas 122. The higher pressure of the inert gas 123 prevents non-inert gas from entering the inert gas buffer 118; safely isolating the second gas supply 122 from non-inert gas. The VSR-11 and the VGC-11 valves are opened allowing fuel from the second gas supply 122 to mix with fuel from the first gas supply 120 and flow to the primary outer port 103.

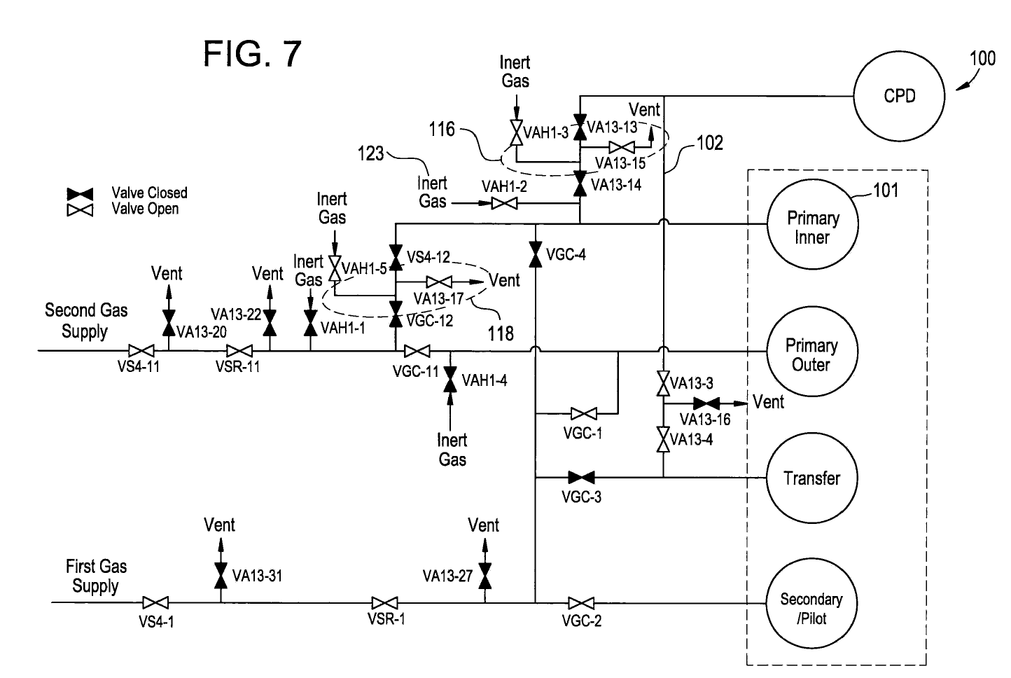

FIG. 7 illustrates an example of the alignment of the system 100 that prepares the system to output blended fuel via the primary inner port 101. The valve VA13-17 is opened allowing the inert gas buffer 118 to be purged with inert gas 123 that is vented via the VA13-17 valve. The VA13-13 and VA13-14 valves are closed preventing the CPD air 113 from flowing through the primary inner manifold 102. The VAH1-3 and VA13-15 valves are opened purging the inert gas buffer 118 with inert gas 123 vented via the VA13-15 valve. The VAH1-2 valve is opened, purging the primary inner manifold 102 and primary inner port 101 with inert gas 123

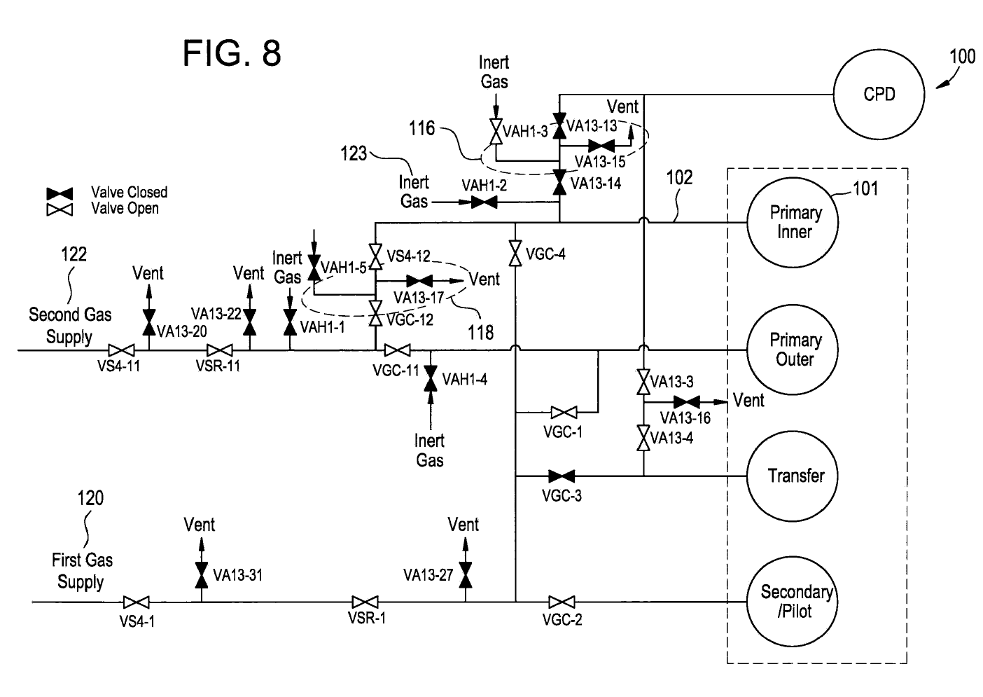

FIG. 8 illustrates an example of the alignment of the system 100 when the primary inner port 101 is receiving a blend of fuel from the first and second gas supplies 120 and 122. The VA13-15 valve is closed, pressurizing the inert gas buffer 116 with inert gas 123. The VAH1-2 valve is closed. The VGC-4 valve is opened, allowing fuel from the first gas supply 120 to flow to the primary inner manifold 102. The VS4-12 and VGC-12 valves are opened allowing fuel from the second gas supply 122 to flow to the primary inner manifold 102 and mix with the fuel from the first gas supply 120. The mixed or blended fuel flows to the primary inner port 101.

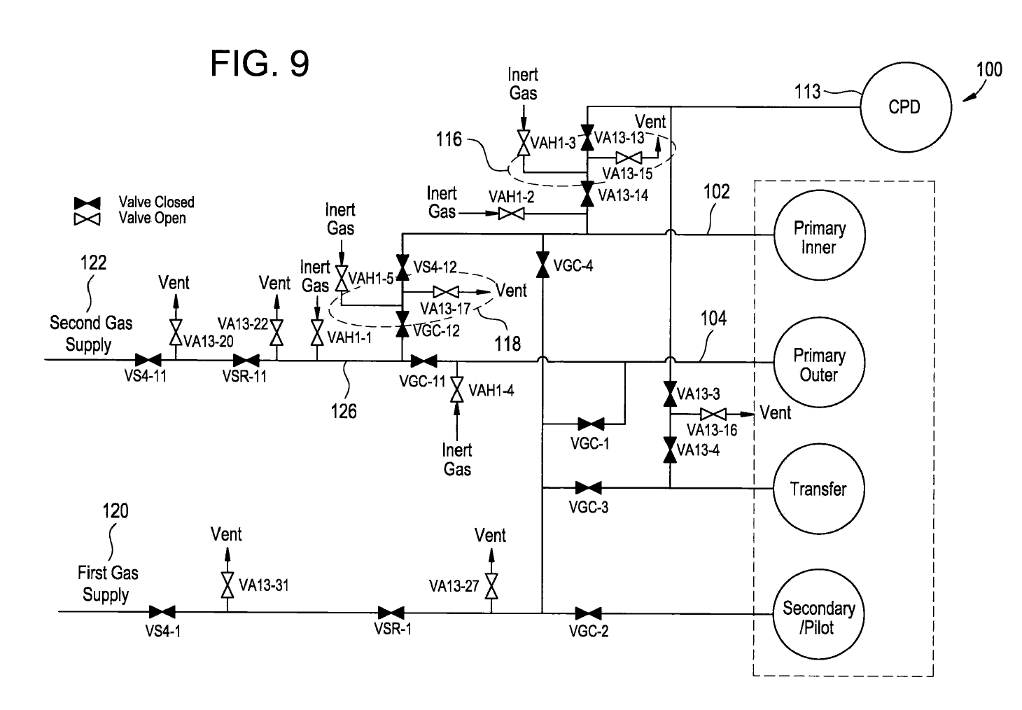

FIG. 9 illustrates an example of the alignment of the system 100 when the system is in a “tripped” or secured mode. In the illustrated example, the vent valves including the vent valves VA13-31 and VA13-27 are opened. The valves controlling the flow of the inert gas 123 including the valve VAH 1-4 are opened allowing inert gas 123 to purge and vent through ports 101 and 103, and to purge and vent from the inert gas buffers 116 and 118. The valves controlling the flow of fuel and CPD air 113 are closed.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel system comprising:
a fuel nozzle having a first port and a second port;
a first manifold connected to the first port; and
a first inert gas buffer portion disposed between the first manifold and a source of compressed air.

2. The system of claim 1, wherein the system further comprises a second manifold connected to the second port.

3. The system of claim 2, wherein the system further comprises:
a first fuel source manifold connected to the first manifold and the second manifold; and
a first fuel source connected to the first fuel source manifold.

4. The system of claim 2, wherein the system further comprises:
a second fuel source manifold connected to the first manifold and the second manifold; and
a second fuel source connected to the second fuel source manifold.

5. The system of claim 4, wherein the system further comprises a second inert gas buffer portion disposed between the second fuel source manifold and the first manifold.

6. The system of claim 1, wherein the first inert gas buffer portion includes a first valve connected to an inert gas source and a first vent valve.

7. The system of claim 1, wherein the system further comprises an inert gas source connected to the first manifold.

8. The system of claim 2, wherein the system further comprises an inert gas source connected to the second manifold.

9. The system of claim 4, wherein the system further comprises an inert gas source connected to the second fuel source manifold.

10. The system of claim 3, wherein the fuel nozzle further comprises a third port and a third manifold connected to the third port and the first fuel source manifold.

11. The system of claim 1, wherein the first manifold is operative to mix natural gas and a second gas.

12. The system of claim 11, wherein the second gas has a hydrogen content of greater than 5%.

13. The system of claim 1, wherein the source of compressed air is compressor discharge air from a gas turbine compressor.

14. A method of controlling a fuel system comprising:
purging a first fuel source manifold with an inert gas;
purging an inert gas buffer portion of the fuel system with the inert gas;
closing a vent valve connected to the inert gas buffer portion; and
stopping the purge of the first fuel source manifold.

15. The method of claim 14, wherein the method further comprises:
supplying fuel from a first fuel source to the first fuel source manifold; and
mixing fuel from a second fuel source and the first fuel source in a first fuel nozzle manifold.

16. The method of claim 14, wherein the method further comprises stopping a flow of compressed air to a second fuel nozzle manifold.

17. The method of claim 16, wherein the method further comprises:
purging a second inert gas buffer portion of the fuel system with the inert gas;
closing a second vent valve connected to the second inert gas buffer portion;
purging a second fuel nozzle manifold with the inert gas;
stopping the purge of the second inert gas buffer portion; and
stopping the purge of the second fuel nozzle manifold.

18. The method of claim 17, wherein the method further comprises
supplying fuel from the first fuel source to the second fuel nozzle manifold; and
mixing fuel from the second fuel source and the first fuel source in the second fuel nozzle manifold.

19. The method of claim 15, wherein the fuel from the first fuel source has a hydrogen content of greater than 5%

20. The method of claim 15, wherein the fuel from the second fuel source is natural gas.
